(19) United States
(12) Patent Application Publication
(10) Pub. No.: US 2011/0298429 A1
(43) Pub. Date: Dec. 8, 2011

(54) POWER PATH MANAGEMENT CIRCUIT AND METHOD

(76) Inventor: Po-Han Chiu, Hsin-Chu (TW)

(21) Appl. No.: 13/151,293

(22) Filed: Jun. 2, 2011

(30) Foreign Application Priority Data
Jun. 4, 2010 (TW) 099118129

(51) Int. Cl. H02J 7/00

(52) U.S. Cl. 320/162

(57) ABSTRACT

Power path management method and circuit are provided. The supply current drained from a power supply is detected and controlled not to exceed a supply current limit . The charge current charging a battery is detected and controlled not to exceed a charge current limit . When the supply current is found to exceed the supply current limit, the charge current limit is decreased.

### BACKGROUND OF THE INVENTION

1. Field of the Invention

The present invention is related to a power path management circuit and a method thereof.

2. Description of the Prior Art

Most portable electronic products, such as mobile phones, possess a battery for power storage/supply purposes. To charge the battery, the portable electronic products are usually bundled with a corresponding charger.

In order for different types of mobile phones to utilize one kind of charger, so that old chargers do not become electronic waste with each new model of mobile phone, the current market trend is to charge the mobile phone through a USB (Universal System Bus) port of a computer. This way, as long as a user has a USB power supply or a USB host, and a USB transmission line, the mobile phone can be charged, so charging is no longer restricted to one type of charger. It is believed that more portable electronic products, in addition to mobile phones, will be charged via the USB port in the near future.

FIG. 1 is a diagram illustrating power path management controller 100, for determining the amount of current drained from a USB port, and at the same time managing an amount of current to be supplied to a system and to a battery via respective power paths. A conventional power management method detects a system voltage, and when the system voltage is too low, the charge current charging the battery is decreased.

### BRIEF DESCRIPTION OF THE DRAWINGS

FIG. 1 is a diagram illustrating a conventional power path management controller.

FIG. 2 is a diagram illustrating a power path management circuit according to an embodiment of the present invention.

FIG. 3 is a diagram illustrating a managing module in FIG. 2.

FIG. 4 is a diagram illustrating another managing module in FIG. 2.

FIG. 5 is a diagram illustrating a reference voltage generator.

### DETAILED DESCRIPTION

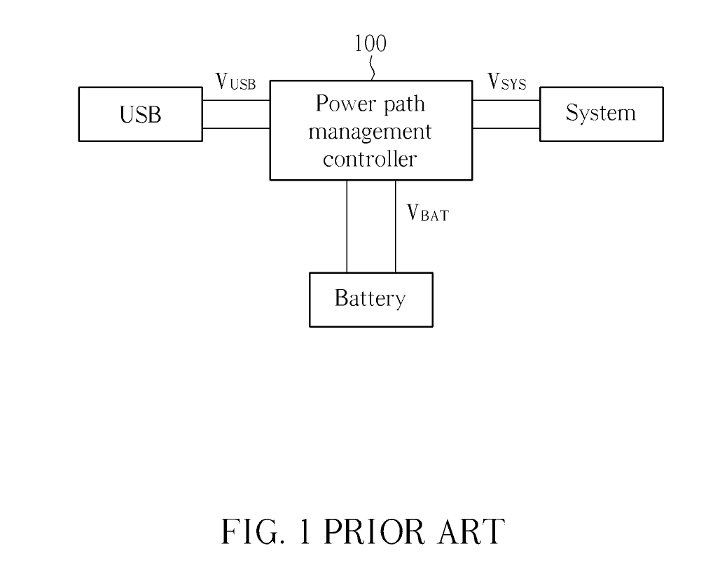

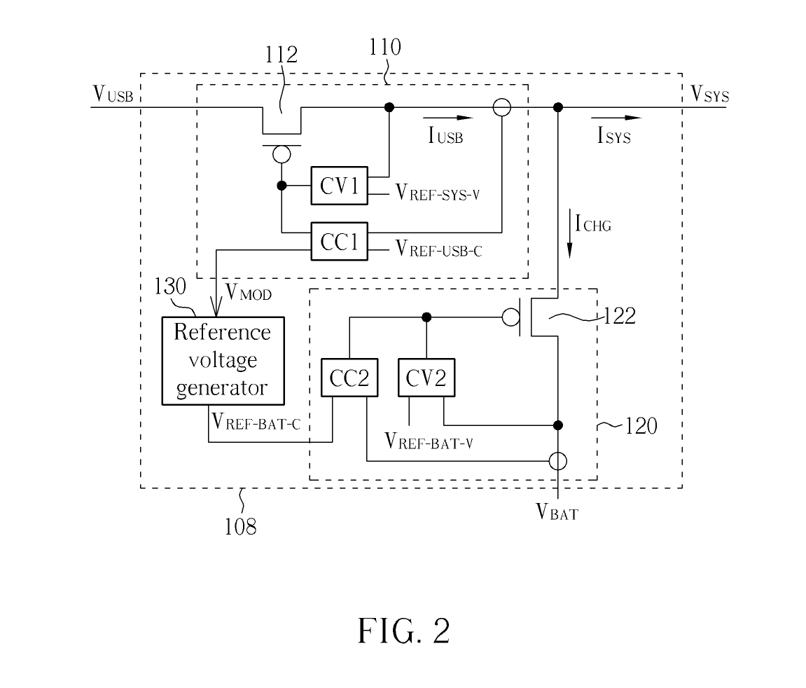

FIG. 2 is a diagram illustrating power path management circuit 108 according to an embodiment of the present invention. Power path management circuit 108 can replace power path management controller 100 in FIG. 1.

In FIG. 2, managing module 110, coupled to power line V_{USB} and a ground line (not illustrated) from a USB port, manages power supplied from the USB port to a system end. Managing module 120 determines power supplied from a system power supply to charge a battery.

PMOS (P-channel metal-oxide semiconductor) 112 of managing module 110 controls a connection between power lines V_{USB} and V_{SYS}. Constant voltage control feedback circuit CV1 detects a voltage level of power line V_{SYS} and controls a gate end of PMOS 112 to make the voltage level of power line V_{SYS} approximately not exceed voltage V_{REF-SYS-V}. Current limiting control feedback circuit CC1 detects USB current I_{USB} drained from power line V_{USB}, and controls the gate end of PMOS 112 to make USB current I_{USB} not exceed current limit I_{USB-LIMIT} corresponding to voltage V_{REF-USB-C}. Simply put, when system current I_{SYS} is small, constant voltage control feedback circuit CV1 maintains the voltage level of power line V_{SYS} to be approximately at voltage V_{REF-SYS-V}. When system current I_{SYS} exceeds current limit I_{USB-LIMIT}, the voltage level of power line V_{SYS} is lower than voltage V_{REF-SYS-V}, and current limiting control feedback circuit CC1 maintains USB current I_{USB} approximately equal to current limit I_{USB-LIMIT}.

Similar to managing module 110, PMOS 122 of managing module 120 controls a connection between power line V_{SYS} and battery power line V_{BAT}. Constant voltage control feedback circuit CV2 prevents voltage level of battery power line V_{BAT} from exceeding voltage V_{REF-BAT-V}. Current limiting control feedback circuit CC2 prevents charge current I_{CHG} for charging the battery from exceeding current limit I_{CHG-LIMIT}, which corresponds to voltage V_{REF-BAT-C}. In other words, when the battery is not fully charged, the voltage level of battery power line V_{BAT} is lower than voltage V_{REF-SYS-V}, and current limiting control feedback circuit CC2 controls charge current I_{CHG} approximately equal to current limit I_{CHG-LIMIT} to charge the battery. When the battery is fully charged, a voltage level of the battery approximately is equal to voltage V_{REF-BAT-V}, and charge current I_{CHG} is less than current limit I_{CHG-LIMIT}.

Reference voltage generator 130, controlled by current limiting control feedback circuit CC1, controls and adjusts voltage V_{REF-BAT-C} according to USB current I_{USB}. When current limiting control feedback circuit CC1 detects USB current I_{USB} has exceeded current limit I_{USB-LIMIT}, voltage V_{REF-BAT-C} decreases continuously, thereby current limit I_{CHG-LIMIT} decreasing accordingly, so charge current I_{CHG} and USB current I_{USB} both decrease until charge current I_{CHG} does not exceed current limit I_{CHG-LIMIT}.

When system current I_{SYS} is small (e.g. when loading of the system is low or negligible), constant voltage control feedback circuit CV1 can stabilize the voltage level of power line V_{SYS} to be voltage V_{REF-SYS-V}. If the battery is not fully charged, meaning the voltage level of battery power line V_{BAT} is lower than voltage V_{REF-BAT-V}, charge current I_{CHG} can charge the battery with the maximum current, i.e. the current limit I_{CHG-LIMIT}.

When loading of the system is high, a sum (i.e. USB current I_{USB}) of system current I_{SYS} and charge current I_{CHG} may have reached current limit I_{USB-LIMIT}. At this moment, if system current I_{SYS} continues to increase, since voltage V_{REF-BAT-C} is decreased by reference voltage generator 130, charge current I_{CHG} is forced to decrease until the sum of system current I_{SYS} and charge current I_{CHG} equals current limit I_{USB-LIMIT}.

When loading of the system is even higher, system current I_{SYS} required may exceed current limit I_{USB-LIMIT}. At this moment, USB current I_{USB} is limited to current limit I_{USB-LIMIT}. Charge current I_{CHG} causes PMOS 122 to stay turned on due to an effect of constant voltage control feedback circuit CV2. Therefore, a direction of charge current I_{CHG} is reversed and the battery supplies power to power line V_{SYS}, for compensating a deficit between USB current I_{USB} and required system current I_{SYS}.

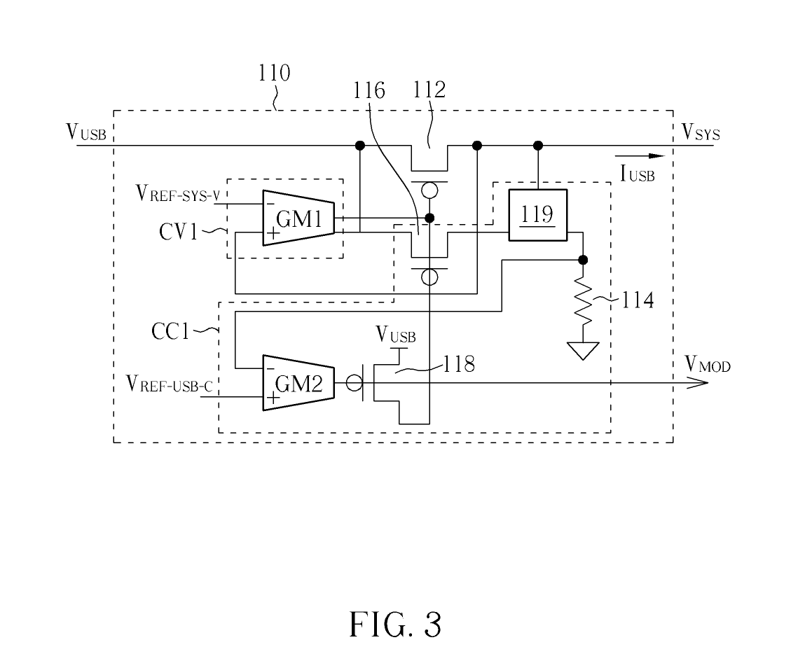

FIG. 3 is a diagram illustrating managing module 110 in FIG. 2. Constant voltage control feedback circuit CV1 comprises a transconductor GM1. Constant voltage control feedback circuit CV1 and PMOS 112 together can be seen as a linear dropout (LDO). The linear dropout is known by those skilled in the art, so related operations and functions are omitted hereinafter. In current limiting control feedback circuit CC1, voltage controller 119 controls a resistance between PMOS 116 and resistor 114, making a voltage level of one end of PMOS 116 approximately equal to the voltage level of power line V_{SYS}. Therefore, PMOS 116 approximately maps a current (I_{USB}) flowing through PMOS 112. Hence, a voltage across resistor 114 is approximately proportional to USB current I_{USB}. Transconductor GM2 and PMOS 118 together can be seen as a unidirectional transconductor which only charges the gate end of PMOS 112. When transconductor GM2 detects that the voltage across resistor 114 is higher than voltage V_{REF-USB-C}, a charge current of PMOS 118 charging the gate end of PMOS 112 is required to be greater than a discharge current generated by transconductor GM1. In other words, current limiting control feedback circuit CC1 takes precedence in controlling PMOS 112 over constant voltage control feedback circuit CV1. Current limiting control feedback circuit CC1 can limit USB current I_{USB} to not exceed current limit I_{USB-LIMIT} corresponding to voltage V_{REF-USB-C}. An output of transconductor GM2 is labeled as modifying signal V_{MOD}. When USB current I_{USB} is higher than current limit I_{USB-LIMIT}, a voltage level of modifying signal V_{MOD} drops continuously. When USB current I_{USB} is lower than current limit I_{USB-LIMIT}, the voltage level of modifying signal V_{MOD} approximately equals that of power line V_{USB}.

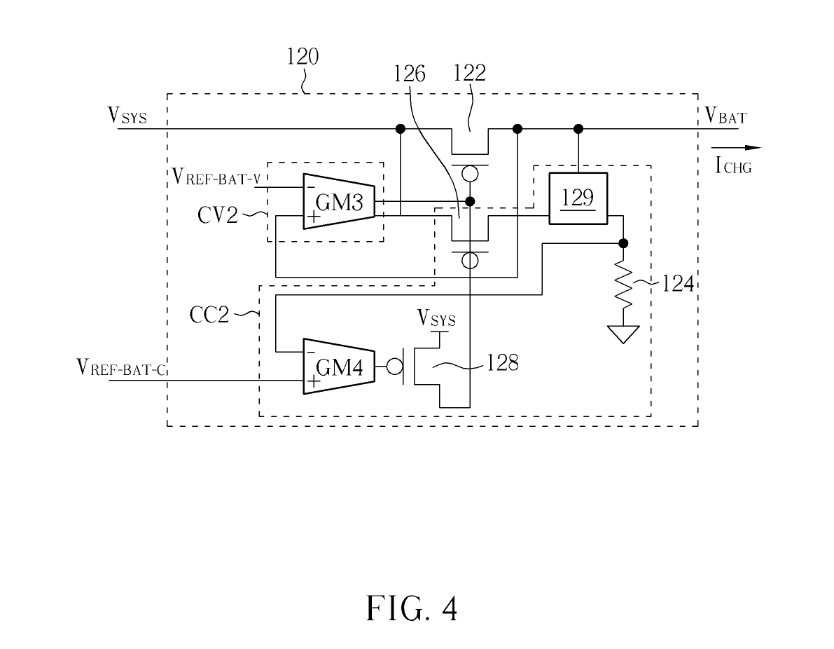

FIG. 4 is a diagram illustrating managing module 120 in FIG. 2. By comparing FIG. 4 with FIG. 3, it can be seen that FIG. 4 is similar to FIG. 3 and the difference is the received/outputted signals. Hence, operations and functions of FIG. 4 are similar to FIG. 3 and description thereof is omitted hereinafter. It is noted that voltage V_{REF-USB-C}, which is for limiting current, in FIG. 3 is approximately a constant, but voltage V_{REF-BAT-C}, which is for limiting current, in FIG. 4 is controlled by reference voltage generator 130. A circuit structure of managing module 120 may be different from that of managing module 110, and can be modified according to practical demands. For instance, managing module 120 comprises a completely different circuit structure than managing module 110 in another embodiment.

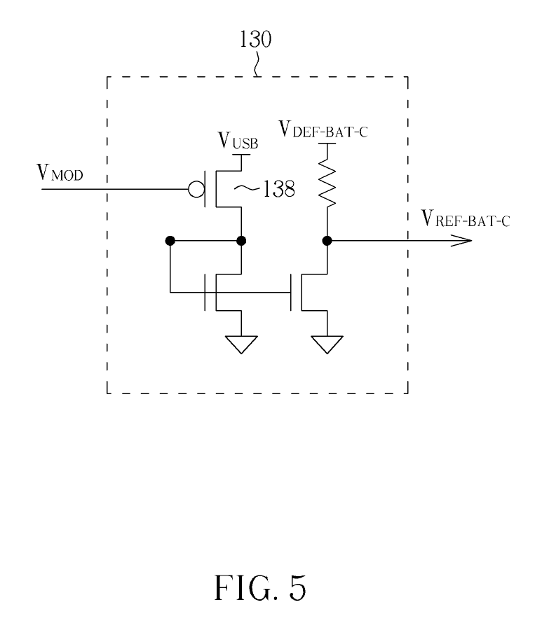

FIG. 5 is a diagram illustrating reference voltage generator 130. When the voltage level of modifying signal V_{MOD} equals the voltage level of power line V_{USB}, PMOS 138 is turned off, so voltage V_{REF-BAT-C} equals default voltage V_{DEF-BAT-C}. When the voltage level of modifying signal V_{MOD} decreases, PMOS 138 starts turning on and voltage V_{REF-BAT-C} decreases accordingly, consequently decreasing current limit I_{CHG-LIMIT}, which results in decreasing charge current I_{CHG}.

Although embodiments above utilize a USB power supplied by the USB port, the present invention is not limited to this and other input powers are also applicable.

Those skilled in the art will readily observe that numerous modifications and alterations of the device and method may be made while retaining the teachings of the invention.

What is claimed is:

1. A power path management circuit, for managing a power supply to supply power to a system and to charge a battery, the power path management circuit comprising:
a first managing module, coupled to the power supply, for controlling a supply current drained from the power supply, the first managing module comprising a first current limiting control feedback circuit for detecting the supply current and controlling the supply current not to exceed a supply current limit;
a second managing module, coupled to the battery, for controlling a charge current charging the battery, the second managing module comprising a second current limiting control feedback circuit for controlling the charge current approximately not to exceed a charge current limit; and
a modifier, coupled to the first current limiting control feedback circuit, for adjusting the charge current limit according to the supply current.

2. The power path management circuit of claim 1, wherein
the first managing module comprises:
an output end, coupled to the system, for providing a system current to supply power to the system, and the charge current to charge the battery; and
a first power switch controlled by the first current limiting control feedback circuit;
the second managing module comprises:
a charge end, coupled to the battery, for providing the charge current for the second managing module to adjust a magnitude and a direction of the charge current; and
a second power switch controlled by the second current limiting control feedback circuit; and
when the supply current exceeds the supply current limit, the modifier decreases the charge current limit, making the supply current approximately not to exceed the supply current limit.

3. The power path management circuit of claim 2, wherein the first current limiting control feedback circuit comprises:
a first transconductor, for comparing a supply voltage signal corresponding to the supply current with a reference supply voltage signal corresponding to the supply current limit, and then outputting a modifying signal to the modifier.

4. The power path management circuit of claim 3, wherein the first current limiting control feedback circuit outputs a first control signal according to a comparison result of the first transconductor to control the first power switch and further adjust the supply current not to exceed the supply current limit.

5. The power path management circuit of claim 2, wherein the first managing module further comprises a first constant voltage control feedback circuit for controlling the first power switch, making a voltage of the output end of the first managing module approximately not to exceed a voltage limit.

6. The power path management circuit of claim 5, wherein the first constant voltage controlled feedback circuit comprises a transconductor, for comparing the voltage of the output end with the voltage limit, outputting a control signal to control the first power switch, and further adjusting the voltage of the output end approximately not to exceed the voltage limit, wherein the first current limiting control feedback circuit takes precedence in controlling the first power switch over the first constant voltage controlled feedback circuit.

7. The power path management circuit of claim 2, wherein the second current limiting control feedback circuit comprises:
a transconductor, for comparing a reference charge signal with a charge voltage signal corresponding to the charge current;
wherein the reference charge signal corresponds to the charge current limit and is provided and adjusted by the modifier; and the second current limiting control feedback circuit controls the second power switch according to a comparison result of the transconductor to adjust the charge current not to exceed the charge current limit.

8. The power path management circuit of claim 7, wherein the second managing module further comprises:
a constant voltage control feedback circuit, for controlling a voltage of the charge end of the second managing module not to exceed a battery voltage limit.

9. The power path management circuit of claim. 8, wherein the second constant voltage controlled feedback circuit comprises another transconductor, for comparing the voltage of the charge end with the battery voltage limit, controlling the second power switch, and adjusting the voltage of the charge end not to exceed the battery voltage limit, and the second current limiting control feedback circuit takes precedence in controlling the second power switch over the second constant voltage control feedback circuit.

10. The power path management circuit of claim 1, wherein when a system current consumed by the system exceeds the supply current limit, the second managing module changes a direction of the charge current for the battery to discharge.

11. A power path management method, for managing a power supply supplying power to a system and charging a battery, the method comprising:
detecting a supply current drained from the power supply;
controlling the supply current to not exceed a supply current limit;
detecting a charge current charging the battery;
controlling the supply current not to exceed a charge current limit; and
when the supply current approximately exceeds the supply current limit, decreasing the charge current limit.

12. The power path management method of claim 11, further comprising:
controlling a system voltage supplying power to the system not to exceed a voltage limit; and
controlling a charging voltage charging the battery not to exceed a battery voltage limit.

13. The power path management method of claim 12, wherein when the charge voltage is lower than the battery voltage limit and the supply current is less than the supply current limit, the charge current charges the battery with the charge current limit.

14. The power path management method of claim 11, wherein when the system current exceeds the supply current limit, a direction of the charge current is changed for discharging the battery to supply the system current.
